(19) United States
(12) Patent Application Publication
(10) Pub. No.: US 2010/0163544 A1
(43) Pub. Date: Jul. 1, 2010

(54) TUBE FOR FIXATION AND METHOD OF PRODUCING SAME

(75) Inventors: Kiyotaka Shirai, Tsubame-shi (JP); Takashi Yaoita, Tsubame-shi (JP); Kenji Chonabayashi, Tsubame-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: K.K. ENDO SEISAKUSHO, Tsubame-shi, Niigata (JP)

(21) Appl. No.: 12/303,883

(22) PCT Filed: Jun. 7, 2007
(86) PCT No.: PCT/JP2007/061579

§ 371 Date: Dec. 8, 2008

(30) Foreign Application Priority Data
Jun. 8, 2006 (JP) 2006-160059

(51) Int. Cl. H05B 1/00; B21D 31/00

(52) U.S. Cl. 219/216; 72/378

(57) ABSTRACT

A tube for fixation, which has increased durability and a method of producing the same are provided.

Forming by spinning is carried out so as to thin the thickness A of a side wall of a bottomed prime tube 1 of a plastically deformable metal to a thickness of 20 to 50 μm while rotating the bottomed prime tube 1 about the axis thereof and a metal original form 4 is formed. The metal original form 4 formed by spinning is cut to form a metal tube 6. The surface 6a of the metal tube 6 is sandblasted to impart residual compression stress to the surface 6a and to roughen the same. The treated surface is covered with a fluorocarbon resin film 7. The fluorocarbon resin film 7 is then heated to be heat-shrunk and the fluorocarbon resin film 7 is formed on the metal tube 6. Thus, a tube for fixation 8 is formed.

### FIELD OF TECHNOLOGY

The present invention relates to a technology for producing a tube for fixation and, in particular, to a tube for fixation, which is used in an electro-photographic printer, a copier or the like and which can be used as a roller such as a photosensitive drum, and to a method for producing the tube for fixation.

### BACKGROUND

A tube for fixation is conventionally applied as part of an image-forming device. This tube for fixation has different functions in use for a monochrome copy, a color copy or in a color printer. Generally, this tube for fixation is obtained by coating a fluorocarbon resin or the like on a metal original form which is molded in the shape of a cylinder by heat-shrinking.

As a technology for molding a metal original form, the present applicant proposed a technology for machining a thin-walled cylindrical metal body by performing rotational plastic working, that is, forming by spinning (See Japanese Patent Application Laid Open No. 2004-174555: Patent Document 1, for example). The molding which accompanies this machining is performed by means of cold or warm drawing. However, as the molding formed by spinning yields a bottomed prime tube and the two ends of the bottomed prime tube are thus cut off to obtain the cylindrical metal body.

Furthermore, as a tube forming technology in which a fluorocarbon resin is coated on a metal original form, a fluorine tube for a fixing member with an axial direction shrinking rate of 1 to 8% and a radial shrinking rate of 2 to 8% during heating at 150° C. is disclosed (See Republished Patent No. WO2003/012555: Patent Document 2, for example). In addition, a technology for forming an endless-belt fluorine tube on the outside face of the metal tube is disclosed (See Japanese Patent No. 3712086: Patent Document 3, for example).

The tube for fixation of the present invention is normally used as follows in a copier, for example. In a copier, image exposure is performed on a photosensitive drum at the surface of which the electrical resistivity varies depending on the received light, thereby forming an electrostatic latent image. Toner, which is magnetic powdered ink, is made to adhere to the formed electrostatic latent image on the photosensitive drum, thereby forming an image of attached toner. The image formed by the attached toner is transferred to paper. This transfer is carried out by applying positive electric charge to the back face of the paper via a transfer roller and transferring the toner on the surface of the photosensitive drum to the paper. Following the transfer, the paper is separated from the photosensitive drum. Then, from the unfixed state of the transferred image of the attached toner, the image is fixed by heating the paper with the toner image, softening the toner and fixing the toner under pressure to form a copy.

The tube for fixation of the present invention is used as a photosensitive drum or the like in such copying process. As mentioned above, the photosensitive drum is made by coating a metal original form with a resin tube constituting a coating material. The photosensitive drum is exposed to harsh conditions for use such as heating and is required to be durable. However, problems such as peeling of the coating material from the photosensitive drum should not occur no matter how harsh the environment in use may be.

In other words, the coating of the metal original form with the coating material must be reliable and in a state in which the coating material is coated on the metal original form in a reliable and stable manner. Prior arts disclose the process itself of performing a surface treatment on the metal original form and providing a primer layer. However, the prior arts do not disclose the technical means which solve the problems mentioned above by processing which is effective when the metal original form is a plastic formed part by drawing.

### SUMMARY OF THE INVENTION

The present invention was devised in view of the problems, which the prior arts of the kind mentioned above suffered from, and achieves the following object.

An object of the present invention is to provide a tube for fixation adapted for plastic formed parts by drawing and a method for producing the same, wherein the residual compression stress is increased prior to coating the metal original form, which is the original form of the tube for fixation, with coating material so as to prevent metallic fatigue of the drawn plastic formed parts and extend its lifetime and the surface is roughened to improve the coating properties, that is, the adhesiveness of the coating material.

The present invention employs the following means in order to achieve the object mentioned above.

In the first aspect of the invention a method of producing a tube for fixation is provided comprising:

a step of performing plastic working by drawing to thin the thickness of a side wall of a cylindrical original form of a plastically deformable metal to a thickness of 20 to 50 μm while rotating the cylindrical original form about the center axis thereof so as to form a thin-walled annular body,

a step of imparting compression strength of imparting residual compression stress to the surface layer of the surface of the thin-walled annular body,

a roughening step of roughening the surface; and

a coating step of covering the roughened surface with coating material and heating the coating material to generate heat-shrinking of the coating material, thereby forming the coating material on the surface.

In the second aspect of the invention, the method of producing a tube for fixation according to the first aspect is further characterized in that the step of imparting compression strength and the roughening step are performed by a sandblasting step of roughening the surface and imparting residual compression stress to the surface by projecting abrasive material made of alumina (Al₂O₃) material with a blast size No. 220 to 400 at a projection pressure of 0.098 to 0.39 MPa (1 to 4 kgf/cm²).

In the third aspect of the invention, the method of producing a tube for fixation according to the first or second aspect is further characterized in that plastic working by drawing is forming by spinning.

In the fourth aspect of the invention, the method of producing a tube for fixation according to the first or second aspect is further characterized in that the metal is stainless steel material.

In the fifth aspect of the invention, the method of producing a tube for fixation according to the first or second aspect is further characterized in that a step of cutting both ends of the thin-walled annular body is carried out after the plastic working by drawing.

In the sixth aspect of the invention, the method of producing a tube for fixation according to the first or second aspect is further characterized in that the coating material is a fluorocarbon resin.

In the seventh aspect of the invention, the method of producing a tube for fixation according to the second aspect is further characterized in that the sandblasting step is a step which is performed under processing conditions such that a deformation ratio, which is the ratio between the difference from maximum to minimum values of an outer diameter dimension of the tube for fixation and the outer diameter dimension of the tube for fixation, is 2.5% or less.

In the eighth aspect of the invention, a tube for fixation is provided which is obtained by performing plastic working by drawing to thin the thickness of a side wall of a cylindrical original form of a plastically deformable metal to a thickness of 20 to 50 μm while rotating the cylindrical original form about the center axis thereof and by imparting residual compression stress to the surface of the metal which has been plastic-worked by drawing, roughening the surface, covering the roughened surface with a fluorocarbon resin film, heating the fluorocarbon resin film so as to be heat-shrunk, thus forming the fluorocarbon resin film on the surface.

In the ninth aspect of the invention, the tube for fixation according to the eighth aspect is further characterized in that as to the imparting of residual compression stress and the roughening, sandblasting of roughening the surface and imparting residual compression stress to the surface are performed by projecting abrasive material made of alumina (Al₂O₃) material with a blast size No. 220 to 400 at a projection pressure of 0.098 to 0.39 MPa (1 to 4 kgf/cm²) so as to roughen the surface and impart residual compression stress to the surface.

In the tenth aspect of the invention, the tube for fixation according to the ninth aspect is further characterized in that a deformation ratio of the tube for fixation, which is a ratio between the difference from maximum to minimum values of an outer diameter dimension of the tube for fixation and the outer diameter dimension of the tube for fixation, is 2.50 or less.

The tube for fixation and the method for producing the same according to the present invention involve sandblasting to the surface of a cylindrical metal body with good workability which has been molded to be a thin body by means of plastic working by drawing and then performing a coating process, thereby producing the tube for fixation. Hence, residual compression stress is imparted to the tube for fixation by means of this process in order to raise the fatigue strength, while the surface area of the tube is increased by roughening of the surface thereof. As a result, it is possible to produce a tube for fixation which has stable strength and increased reliability in adhesiveness of coating material without probability of peeling of the coating layer even under harsh conditions in use such as with heating.

### BRIEF DESCRIPTION OF DRAWINGS

FIG. 1 is a cross-sectional view of a tube for fixation which shows the constitution of the present invention;

FIG. 2 is an explanatory diagram showing an arrangement of forming a metal original form by spinning;

FIG. 3 is an explanatory diagram showing an arrangement in which a metal original form which has undergone forming by spinning is cut to obtain a metal tube;

FIGS. 4A and 4B show deformed states when a metal tube which has undergone sandblasting is cut, where FIG. 4A is a perspective view indicating the cutting position, FIG. 4B is a perspective view of the deformed state of the metal tube after cutting, and FIG. 4C is a perspective view of the deformed state of a metal tube produced by the prior art after the metal tube has been cut;

FIG. 5 is an explanatory diagram showing an arrangement in which a metal tube undergoes sandblasting;

FIG. 6 is a graph which shows test results obtained with a blast size No. 320 and in which the surface roughness has been plotted;

FIG. 7 is a graph which shows test results obtained with a blast size No. 320 and in which the peel strength has been plotted;

FIG. 8 is a graph which shows test results obtained with a blast size No. 220 and in which the surface roughness has been plotted; and

FIG. 9 is a graph which shows test results obtained with a blast size No. 220 and in which the peel strength has been plotted.

### DETAILED DESCRIPTION OF PREFERRED EMBODIMENTS

An embodiment of the tube for fixation and the method for producing the same of the present invention will now be explained, including Examples which show experiment results.

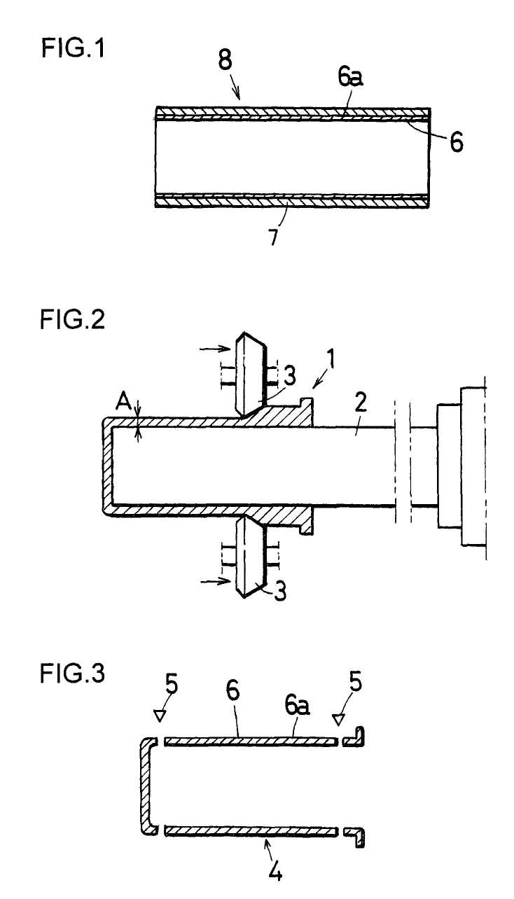

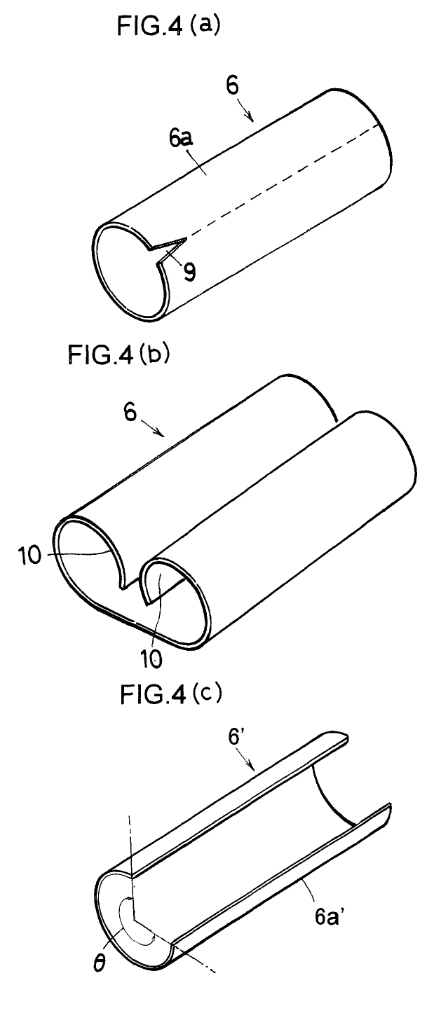

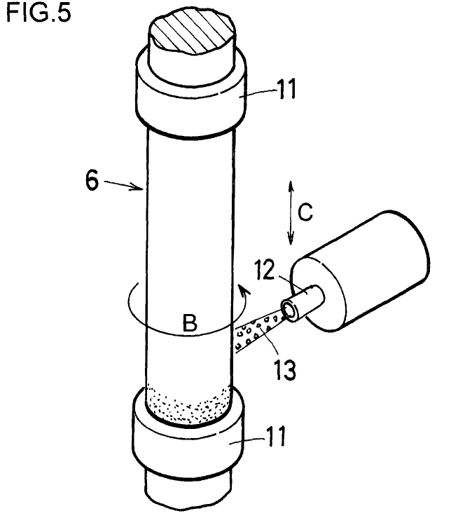

FIG. 1 is a cross-sectional view of a tube for fixation which shows the constitution of the present invention; FIG. 2 is an explanatory diagram showing an arrangement of forming a metal original form by spinning; FIG. 3 is an explanatory diagram showing an arrangement in which a metal original form which has undergone forming by spinning is cut to obtain a metal tube; FIGS. 4A and 4B show deformed states when a metal tube which has undergone sandblasting is cut, where FIG. 4A is a perspective view indicating the cutting position, FIG. 4B is a perspective view of the deformed state of the metal tube after cutting, and FIG. 4C is a perspective view of the deformed state of a metal tube produced by the prior art after the metal tube has been cut. FIG. 5 is an explanatory diagram showing an arrangement in which a metal tube undergoes sandblasting.

First, an outline of plastic working by drawing of a metal original form 4, which is the original form of a tube for fixation 8, will be explained. While the applicant of the present invention disclosed this plastic working by drawing in Patent Document 1, the gist of this plastic working by drawing will be described here in order to facilitate understanding of the present invention, because it forms the basis of the production of the metal original form 4 of the tube for fixation 8 according to the present invention.

Machining which uses a spinning machine is performed in which a bottomed prime tube pre-machined by press working or the like from a thin sheet metal is made to be thinner in thickness. The thin sheet metal is of stainless material such as SUS304 (corresponding to U.S. AISI304) or the like. The thin sheet metal may also be of metal other than stainless material, such as copper, nickel, iron or the like. As shown in FIG. 2, a bottomed prime tube 1 which was worked by pressing beforehand is held on and rotated by a rotating axle 2 of the spinning machine. Pivot blocks 3, which are forced in press-contact with the side wall of the bottomed prime tube 1, are advanced in the direction of the arrow.

Under the pressing force of the pivot blocks 3 along with the rotation, the bottomed prime tube 1 is gradually squeezed and grows longer as the pivot blocks 3 advance. The pivot block 3 is a type of jig which has a beadlike shape and is provided rotatably. A feature of this forming by spinning is the capability of thinning wall thickness A. For example, at the stage of the bottomed prime tube 1, its wall thickness A can be made to be 20 to 50 μm. In the case of SUS304, this machining is performed with a limit drawing ratio raised up to 2.6 in the warm drawing. For example in the case of SUS304, the metal original form 4, which has undergone forming by spinning in this manner, comes to have a tensile strength of 1666 MPa (170 kgf/mm²) and a fatigue strength of 980 MPa (100 kgf/mm²) or more which may vary depending on the conditions.

When forming by spinning has been performed in this manner and a thin-walled metal original form 4 is obtained, the metal original form 4 is then removed from the rotating axle 2 and, as shown in FIG. 3, the two ends of the metal original form 4, which has been machined with the wall thickness A, are cut off by a cutting tool 5. As a result of this cutting, the tubular body at the center becomes a metal tube for fixation 6, a photosensitive drum or the like. Thereafter, the metal tube 6 undergoes low-temperature annealing at a temperature of around 450° in order to control the elastic properties, remove the internal stress and achieve a uniform shape. This low temperature annealing increases the hardness of the metal tube 6 and raises the tensile strength and fatigue strength.

The metal tube 6, the hardness, tensile strength and fatigue strength of which have been raised to a certain extent in this way, is sandblasted as shown in FIG. 5. The sandblasting is performed in order to generate irregularities in the surface 6a of the metal tube 6, thereby increasing the surface area, and activating the surface 6a. As a result, the residual compression stress is generated in the surface 6a and the fatigue strength is raised. The sandblasting which is generally performed is shot-peening. This processing is performed also in this embodiment.

The metal tube 6 is supported at its two ends by a chuck 11 and is rotated in a predetermined direction (in the direction of arrow B, for example) with a predetermined rotational frequency. A nozzle 12 can be moved up and down (in the direction of arrow C) in FIG. 5 and blows fine spherical abrasive material (shot) 13 onto the surface 6a of the metal tube 6. That is, the nozzle 12 blows the fine spherical abrasive material (shot) 13 onto the surface 6a to provide irregularities on the surface 6a, remove residual tensile stress and raise the residual compression stress. In other words, by sandblasting to the surface 6a with the abrasive material (shot), shocks are imparted to the surface 6, the residual tensile stress is removed and the residual compression stress is raised.

Furthermore, providing surface irregularities by means of the abrasive material (shot) 13 increases the surface area, roughens the surface 6a, and raises the adhesiveness in the coating process, which will be described subsequently. The processes of imparting compression strength and roughening the surface 6a in this embodiment involve roughening the surface 6a of the metal tube 6 and providing the surface 6a with residual compression stress by sandblasting the surface 6a by means of abrasive material (shot) made of alumina (Al₂O₃) material with a blast size No. of 220 to 400 (particle size #220 to 400) under projection pressure (shot pressure) of 0.098 to 0.39 MPa (1 to 4 kgf/cm²).

In the field of shot-peening, a method is known in which abrasive material (shot) is projected onto a test piece such as an aluminum strip and measurement of the amount of deformation following the projection is made in order to measure the degree of residual compression stress imparted to the surface. The test piece, which was plate-like prior to the projection, cambers so as to be convex on the side of projection after the abrasive material has been projected. The height of the amount of curvature is measured using an aluminum gauge. In other words, after the shot-peening, it can be confirmed whether residual compression stress has been imparted, depending on whether there is or is not an amount of curvature such that the projection side is then convex.

In this embodiment, it is also checked whether residual compression stress has been imparted. As shown in FIG. 4A, when the sandblasted metal tube 6 is cut along the broken line from the cutout 9, the metal tube 6 is deformed such that the two ends 10, 10 curl inward as shown in FIG. 4B. In other words, because residual compression stress is imparted by the sandblasting, the projection side becomes convex, thus yielding such deformation. For the sake of a comparison, a metal tube 6′, which has been fabricated by the prior art, is shown in its cut-off state in FIG. 4C. The metal tube 6′ of the prior art is deformed such that the two cut ends spread at an angle θ, as shown in FIG. 4C.

The sandblasting is performed on the metal tube 6 which is obtained by cutting a metal original form 4 of a wall thickness A of 20 to 50 μm which has been molded by plastic working by drawing as mentioned earlier. When the fluorocarbon resin film with which the metal tube 6 is coated is heated, the fluorocarbon resin film then undergoes heat-shrinking and comes to adhere to the surface 6a of the metal tube 6 with irregularities on it. A coarser roughness is effective for the irregularities. The above mentioned sandblasting is performed in order to obtain such an effect. As a result, the peel strength is raised.

As described hereinabove, the processes of imparting residual compression stress to the surface 6a and of roughening the same are carried out simultaneously by means of sandblasting in this embodiment. However, these two processes can also be performed separately. For example, the process of roughening the surface 6a can also be performed by means of grinding or processing by laser. Then the coating described below is performed on the metal tube 6 whose surface has been treated in this manner.

A coating material 7 in this coating process is a fluorocarbon resin. The coating material is placed and heat-shrunk by being heated, thus coating on the surface 6a of the metal tube 6 being performed. The coating layer resulting from the coating process acts as a protective film for the metal tube 6 and prevents oxidation of the surface 6a of the metal tube 6. The coating layer also functions so as to facilitate peeling of paper for transfer when the paper is wound on the metal tube 6.

The fluorocarbon resin of the coating material 7 is a polymer which is thermoplastic and can be molded by heating. Examples of material of superior workability, heat resistibility and so forth are a binary copolymer of ethylene and trifluorochloroethylene or a binary copolymer of tetrafluoroethylene and perfluoroalkylvinylether (abbreviated as PFA) or the like. Other than a fluorocarbon resin, a silicone layer and a fluorocarbon resin layer formed on a silicone layer (the compound generally known as ‘Teflon’ (registered trademark)) are also acceptable.

During the coating process, it is important that the coated fluorocarbon resin should not peel from the metal tube. Furthermore, so-called ‘wrinkles’ are readily generated due to differences in heat shrinkage properties. For this reason in this embodiment, shot-peening to add irregularities to the surface 6a of the metal tube 6 is carried out as mentioned earlier in order to prevent the generation of these wrinkles. The addition of irregularities exhibits combined effects of increasing the residual compression stress of the metal tube 6 as well as the prevention of coating layer separation and imparting roughness at the same time.

The process of adding irregularities is suitably applied to stainless steel material but may also be applied for a tube of another metal. Thus, by performing a coating process after carrying out sandblasting (shot-peening), it is possible to reduce the generation of ‘wrinkles’ and ‘cracks’ which are a conventional problem due to differences in the heat shrinkage properties. As described earlier, where the tube for fixation of the present invention is concerned, the metal original form 4, which has been made stronger by means of forming by spinning and thinner in wall thickness A, has undergone sandblasting (shot-peening) and a coating process has been performed. As a result, it is possible to produce the tube for fixation 8 shown in FIG. 1, which is stable and in which there is no peeling even under repeated harsh conditions in use such as with heating.

### Example of Test Result 1

Table 1 shows an example of test results for the peel strength using blast size No. 320.

The test for the peel strength in this example was performed on the metal tube following the sandblasting. Symbols F, C, and B in Table 1 represent the measurement positions. Symbol F represents the position of a flange portion of the metal tube, symbol C represents the position of the tube portion at the center of the metal tube and symbol B represents the position of the base portion of the metal tube at the bottom. The average of the peel strengths in these three measurement positions is 1.23 N/cm² (126 gf/cm²). However, the average of the measurement results of the position of the tube portion at the center, which is the tube for fixation (the position of symbol C), is 1.63N/cm² (166 gf/cm²), which is a measurement result representing a higher peel strength than in the other positions.

TABLE 1

| | Convex maximum point (gf/mm²) | | | |
|---|---|---|---|---|
| | F | G | B | Average |
| 1 | 127 | 178 | 103 | 136 |
| 2 | 73 | 165 | 82 | 107 |
| 3 | 94 | 156 | 152 | 134 |
| Average | 98 | 166 | 112 | 126 |

 Tube film thickness: 50 μm (n = 3)

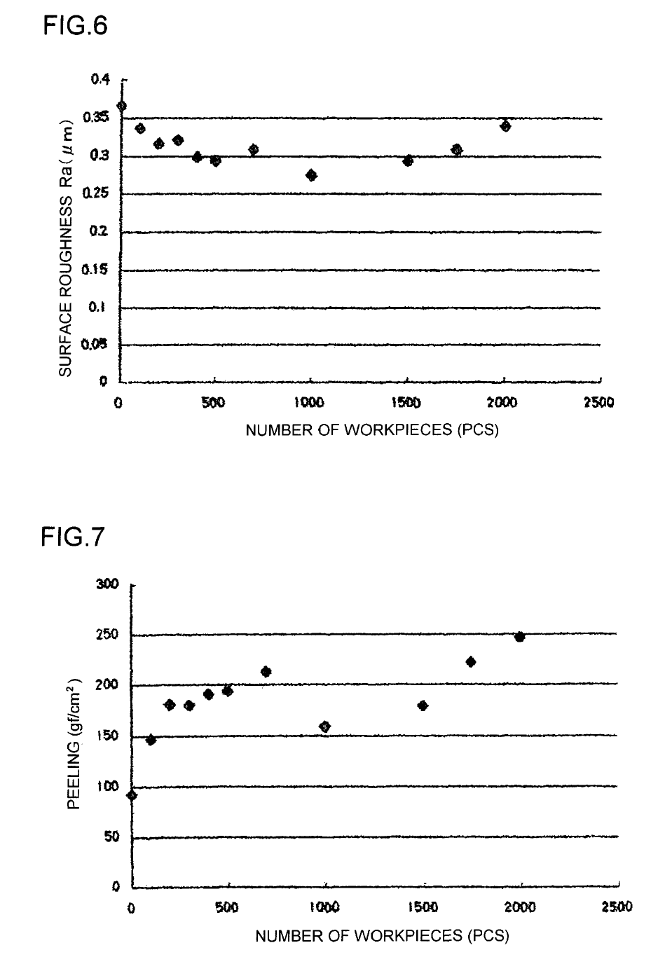

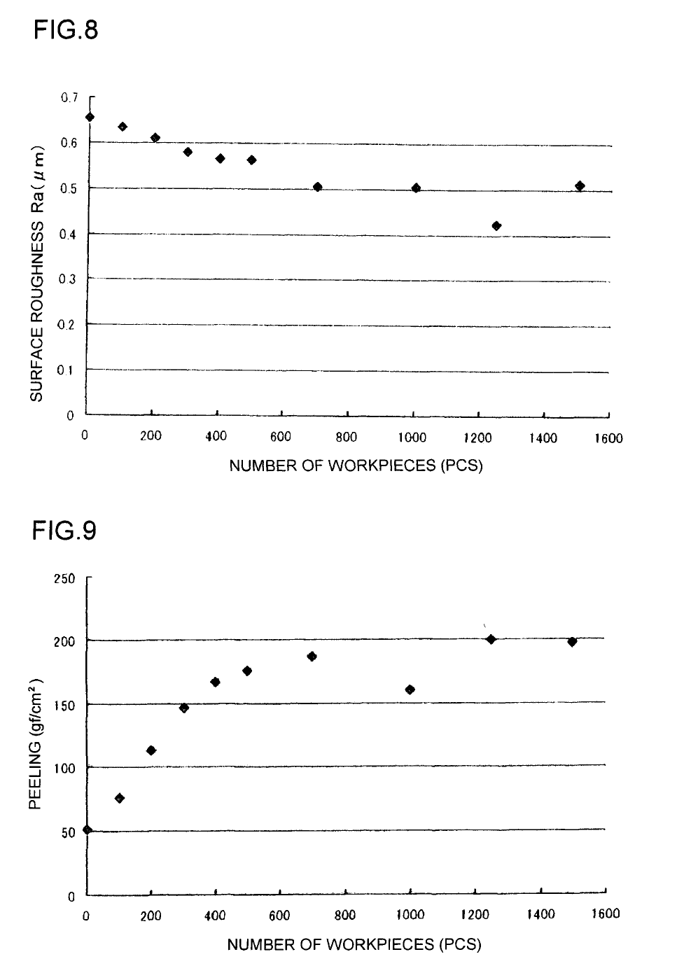

FIGS. 6 and 7 show an example of a test result using blast size No. 320, where FIG. 6 is a graph in which the surface roughness has been plotted and FIG. 7 is a graph in which the peel strength has been plotted. FIGS. 8 and 9 show an example of a test result using blast size No. 220, where FIG. 8 is a graph in which the surface roughness has been plotted and FIG. 9 is a graph in which the peel strength has been plotted. The projection (shot) pressure of the abrasive material (shot) is 0.29 MPa (3.0 kgf/cm²).

FIG. 6 is a graph of a test result which represents the relationship between the number of workpieces and the surface roughness in a test using abrasive material of blast size No. 320. As a result, the film thickness lies in a range of 0.25 to 0.35 μm for 2000 workpieces.

FIG. 7 is a graph of test results which represents the relationship between the number of workpieces and the peel strength in a test using abrasive material of blast size No. 320. As a result, the peel strength lies in a range of 1.47 to 2.45N/cm² (150 to 250 gf/cm²) for 2000 workpieces.

FIG. 8 is a graph of a test result which represents the relationship between the number of workpieces and the surface roughness in a test using abrasive material of blast size No. 220. As a result, the film thickness lies in a range of 0.40 to 0.65 μm for 1500 workpieces.

FIG. 9 is a graph of a test result which represents the relationship between the number of workpieces and the peel strength in a test using abrasive material of blast size No. 220. As a result, the peel strength lies in a range of 0.49 to 1.96N/cm² (50 to 200 gf/cm²) for 1500 workpieces.

As shown in Table 1 and FIGS. 6 to 9, suitable test results were obtained for the tube for fixation with this example.

### Example of Test Result 2

The tube for fixation produced by this production method has an extremely thin wall with thickness A of 20 to 50 μm and has small deformations generated by sandblasting in the circumference thereof. This deformation can be shown as a difference in the outer diameter dimension, which is the difference from maximum to minimum values for the outer diameter dimension. If the outer diameter dimension difference is 0, for example, the circumference can be judged to be a perfect circle. This outer diameter dimension difference varies depending on the sandblasting conditions (the machining time, the projection pressure (shot pressure), the rotational frequency of the metal tube and the nozzle movement velocity, for example). For example, the outer diameter dimension difference tends to be larger when the projection pressure (shot pressure) is made higher.

Table 2 shows data for the outer diameter dimension difference under sandblasting conditions 1, 2, and 3.

For a tube for fixation of φ18 mm, sandblasting conditions were set so that the outer diameter dimension difference was approximately 0.3 mm (processing condition 1), approximately 0.45 mm (processing condition 2) and approximately 0.65 mm (processing condition 3), respectively, and sandblasting was carried out. Following the sandblasting, the outer diameter dimension was measured on the circumferences at twelve points in the axial direction. The outer diameter dimension difference (=the maximum value for the outer diameter dimension−the minimum value for the outer diameter dimension) was determined from the measured maximum and minimum values for the outer diameter dimension. As a result, it was confirmed that the outer diameter dimension difference did not vary very much in any position in the axial direction under processing conditions 1 to 3. In other words, as shown, the ranges (R) were found to be 0.033 mm, 0.088 mm and 0.089 mm, respectively, which exhibit stability of dimension.

TABLE 2

| | Processing | Processing | Processing |
|---|---|---|---|
| | condition 1 | condition 2 | condition 3 |
| Number of measurement | 12 | 12 | 12 |
| points | | | |
| Outer diameter | 0.258 | 0.433 | 0.571 |
| dimension difference | | | |
| (AVE.) | | | |
| Outer diameter | 0.273 | 0.488 | 0.614 |
| dimension difference | | | |
| (MAX.) | | | |
| Outer diameter | 0.240 | 0.400 | 0.525 |
| dimension difference | | | |
| (MIN.) | | | |
| Outer diameter | 0.033 | 0.088 | 0.089 |
| dimension difference | | | |
| (Range: R) | | | |

Thereafter, for a tube for fixation of φ18 mm, it was checked whether outer diameter dimension differences of 0.3 mm, 0.45 mm, and 0.65 mm fulfilled the functions of a tube for fixation. The result was such, that, with an outer diameter dimension difference of 0.65 mm, the tube for fixation did not rotate smoothly and generated idle, whereby bleeding of ink was produced at certain fixed intervals. With outer diameter dimension differences of 0.45 mm and 0.25 mm, the functions of a tube for fixation were exhibited with no problem. In other words, with a tube for fixation of φ18 mm, the outer diameter dimension difference may be 0.45 mm or less. That is, considered with respect to the deformation ratio which is the ratio between the difference from maximum to minimum values of the outer diameter dimension of the tube for fixation and the outer diameter dimension of the same (the outer diameter dimension difference/the outer diameter dimension), suitable results were obtained when the deformation ratio was 2.5% or less. In other words, it is preferred to select the condition of sandblasting such that the deformation ratio, which is the ratio between the outer diameter dimension difference and the outer diameter dimension of the tube for fixation, may be 2.5% or less.

While the present invention has been described for an embodiment thereof hereinabove, it is not limited to this embodiment with Examples. It is understood that various modifications are possible within the scope of the object and spirit of the present invention.

### INDUSTRIAL APPLICABILITY

The present invention can be utilized in the industries of printers, printing press apparatus, copiers, copying machines and so forth, as for rollers of photosensitive drums, etc., of electro-photographic printers, copiers.

What is claimed is:

1. A method for producing a tube for fixation, comprising:
a step of performing plastic working by drawing to thin the thickness of a side wall of a cylindrical original form of a plastically deformable metal to a thickness of 20 to 50 μm while rotating the cylindrical original form about the center axis thereof so as to form a thin-walled annular body,
a step of imparting compression strength of imparting residual compression stress to the surface layer of the surface of the thin-walled annular body,
a roughening step of roughening the surface; and
a coating step of covering the roughened surface with coating material and heating the coating material to generate heat-shrinking of the coating material, thereby forming the coating material on the surface.

2. The method for producing a tube for fixation according to claim 1, wherein the step of imparting compression strength and the roughening step are performed by a sandblasting step of roughening the surface and imparting residual compression stress to the surface by projecting abrasive material made of alumina (Al₂O₃) material with a blast size No. 220 to 400 at a projection pressure of 0.098 to 0.39 MPa (1 to 4 kgf/cm²).

3. The method for producing a tube for fixation according to claim 1 or 2, wherein plastic working by drawing is forming by spinning.

4. The method for producing a tube for fixation according to claim 1 or 2, wherein the metal is stainless steel material.

5. The method for producing a tube for fixation according to claim 1 or 2, wherein a step of cutting both ends of the thin-walled annular body is carried out after the plastic working by drawing.

6. The method for producing a tube for fixation according to claim 1 or 2, wherein the coating material is a fluorocarbon resin.

7. The method for producing a tube for fixation according to claim 2, wherein the sandblasting step is a step which is performed under processing conditions such that a deformation ratio, which is the ratio between the difference from maximum to minimum values of an outer diameter dimension of the tube for fixation and the outer diameter dimension of the tube for fixation, is 2.5% or less.

8. A tube for fixation obtained by performing plastic working by drawing to thin the thickness of a side wall of a cylindrical original form of a plastically deformable metal to a thickness of 20 to 50 μm while rotating the cylindrical original form about the center axis thereof and by imparting residual compression stress to the surface of the metal which has been plastic-worked by drawing, roughening the surface, covering the roughened surface with a fluorocarbon resin film, heating the fluororesin film so as to be heat-shrunk, thus forming the fluororesin film on the surface.

9. The tube for fixation according to claim 8, wherein, as to the imparting of residual compression stress and the roughening, sandblasting of roughening the surface and imparting residual compression stress to the surface are performed by projecting abrasive material made of alumina (Al₂O₃) material with a blast size No. 220 to 400 at a projection pressure of 0.098 to 0.39 MPa (1 to 4 kgf/cm²) so as to roughen the surface and impart residual compression stress to the surface.

10. The tube for fixation according to claim 9, wherein a deformation ratio of the tube for fixation, which is a ratio between the difference from maximum to minimum values of an outer diameter dimension of the tube for fixation and the outer diameter dimension of the tube for fixation, is 2.5% or less.
